(19) United States
(12) Patent Application Publication
(10) Pub. No.: US 2006/0035008 A1
(43) Pub. Date: Feb. 16, 2006

(54) Edible film containing food acid

(75) Inventors: Margaret T Virgallito, Dayton, OH (US); Jing Zhang, Loveland, OH (US)

Correspondence Address: NORRIS, MCLAUGHLIN & MARCUS, 875 THIRD AVE, 18TH FLOOR, NEW YORK, NY, 10022, US

(73) Assignee: Givaudan SA, Vernier (CH)

(21) Appl. No.: 10/533,362

(22) PCT Filed: Nov. 12, 2003
(86) PCT No.: PCT/CH03/00739

§ 371 Date: May 13, 2005

Related U.S. Application Data
(60) Provisional application No. 60/426,442, filed on Nov. 14, 2002.

(30) Foreign Application Priority Data
Jan. 23, 2003 (GB) 0301537.7

(51) Int. Cl. A23L 1/221

(52) U.S. Cl. 426/650

(57) ABSTRACT

An edible film composition for delivering an active agent to the oral cavity, the composition comprising a water-dispersible film composition comprising a cellulose ether and a starch, and a food acid.

The present invention relates to an orally administrable film for delivery of a food acid, and optionally other active agents, to the oral cavity.

Edible films that are rapidly disintegrating in the oral cavity are known in the art. These films are used to deliver breath freshening agents, flavourants, pharmaceutical active agents, nutrients and the like. They generally contain water-soluble polymers and other conventional excipients such plasticisers and emulsifiers. Selection of particular polymers and other excipients are based on considerations of the film properties. Thus, it is conventional to employ a water-soluble polymer that is capable of forming robust films with good mechanical strength; plasticisers are chosen to provide softness and pliability to the films, whereas emulsifiers are used to ensure that films may be cast from a solution in an acceptably uniform manner.

However, applicant is not aware of prior art teaching the selection of film ingredients based on a consideration of their interaction with active agents; essentially the art silent as to film ingredient-active agent interactions and the role they play on film stability and active agent delivery. The skilled person is left with the impression that it has latitude to select film ingredients independent of the nature of the active ingredient to be delivered.

In recent times, the trend has developed for edible films that are multi-functional. That is, it is not only desirable to deliver single active agents, such as flavours, from edible films, it is also desirable to present the consumer with other sensations in the mouth as a result of consuming film. In particular, it is desirable to deliver a tartness or sourness and a mouth-watering sensation. Such a mouth sensation may be achieved with food acids.

However, there are considerable technical challenges associated with incorporating food acids into edible films. In particular, applicant found that a film's mechanical strength was compromised by adding food acid to the film. It was also observed that the films displayed poor hygroscopic stability making them difficult to manufacture and store, and unattractive to consumers. For example, in some cases the films when placed together tend to stick together to form a gum.

It is highly desirable to provide films that can deliver a tartness or sourness and mouth-watering effect and which are mechanically strong and hygroscopically stable.

The applicant has now surprisingly found that by combining certain types of film-forming polymers it is possible to form edible films that rapidly dissolve or disintegrate and disperse in the mouth and which solve the problems referred to above.

Accordingly, the invention provides in a first aspect an edible film for delivering an active agent to the oral cavity comprising a water-dispersible film-forming material selected from a cellulose ether and a starch, and a food acid.

The food acid may be selected from the group consisting of citric acid, malic acid, glacial acetic acid, anthranilic acid, tartaric acid, tiglic acid, ascorbic acid, benzoic acid, tannic acid, succinic acid, adipic acid, fumaric acid and lactic acid.

These food acids, are preferably employed in edible film formulations at levels of at least about 8% by weight based on the dry weight of the edible film composition, more preferably from about 8% to about 25% by weight. Dry weight according to the present invention refers to the weight of all of the edible film composition components without added water. The above-mentioned levels of food acids are preferred in order to give a desirable tartness or sourness impression and to achieve a desirable mouth-watering effect. Whereas, it may be possible to incorporate lower amounts of acid into the films and thereby avoid any instability problems associated with the films, one cannot reliably achieve the desirable mouth-sensations aforementioned.

The acid may be incorporated into the films in encapsulated form. In this manner, high levels of acid (even higher than the amounts aforementioned if desired) may be incorporated without any detrimental effects on the physical properties of the film, however in many applications, the acid has to be released immediately into the mouth as the film disintegrates in order to provide an instant mouth-watering effect. If the acid is encapsulated, the onset of the mouth-watering effect is delayed, in a manner dependant on the release of the acid from the capsule.

Cellulose ethers for use in the present invention may be any of those known materials that are water-swellable, and soluble or dispersible in water and which can be cast or extruded into films. For a discussion of these ethers one can refer to Ullman's Encyclopedia of Chemistry (VCH Verlagsgesellshaft mbH, 1986 revised edition, Vol A 5 at 461 to 488, which is incorporated herein by reference. Preferred materials are selected from the group consisting of methyl celluloses and mixed ethers thereof such as hydroxyethyl methyl cellulose, hydroxypropyl methyl cellulose, hydroxybutyl methyl cellulose, ethyl methyl cellulose, and carboxymethyl methyl cellulose; ethyl cellulose and mixed ethers thereof such as ethyl hydroxyethyl cellulose; hydroxyalkyl cellulose ethers such as hydroxy ethyl cellulose, hydroxypropyl cellulose, hydroxyethylhydroxypropyl cellulose, and carboxymethyl hydroxyethyl cellulose; or mixtures thereof.

The hydroxypropylmethyl cellulose ethers are preferred.

The cellulose ethers are selected for their excellent film-forming ability, their ability to be plasticised using common plasticisers and their ability to be cast or extruded as sheets.

Suitable starches for use in the present invention are any of those known starches or modified starches that rapidly hydrate and disperse or dissolve, and which can be cast or extruded into films. For a discussion of such starches see Ullman's Encyclopedia of Chemistry (VCH Verlagsgesellshaft mbH, 1994 revised edition, Vol A 25 at Ch 2, which is incorporated herein by reference. Starches for use in the present invention may be native starches or modified starches known in the art and which are easily hydrated and disperse or dissolve in water. As starches there can be mentioned corn starch, potato starch, rice starch, tapioca starch, maize starch, sorghum starch, sago starch wheat starch or sodium starch glycolate; or any native starch that has been chemically modified, e.g. acid-modified; or mixtures thereof.

The film-forming materials, that is, the cellulose ethers and starches referred to above, may be employed in varying amounts depending on the nature of the material, the particular film-forming conditions employed, the desired properties of the film, and the nature of the other ingredients employed in the film. For most purposes however, high amounts of the film formers are desirable, and it is preferred if the total amount of film-formers is from 50 to 90%, more particularly 50 to 80% by weight based on the dry weight of the composition.

The ratio of cellulose ether to starch may also vary considerably depending on the disintegration properties sought. Typically one may employ 4 parts cellulose ether to 1 part starch. However, this ratio may vary. For example, if one wants to increase the rate of hydration of the film one can increase the starch content; whereas if one wants to increase the mechanical strength of the film, higher amounts of cellulose ether are preferred.

The edible film may additionally contain gelatin or pectin. Gelatin or pectin may assist in the hydration of the film when it is placed in the mouth. Rapid hydration is important to because customers often associate slow hydration with unpleasant mouth feel. It is preferred if hydration of films occurs in a matter of seconds, e.g. within 30 seconds, more particularly 5 to 10 seconds. Gelatin or pectin may be employed at levels of up to about 30 wt % based on the dry weight of the formulation.

Edible film according to the invention may contain other, optional, ingredients. For example, the film may contain excipients that assist in film formation, handling and stability such as emulsifiers and plasticisers. Other excipients may include preservatives, anti-oxidants, colourants and the like. The films may also contain additional active agents as stated above.

As emulsifiers one can mention lecithin, stearates, ester derivatives of stearates, palmitates, ester derivatives of palmitates, oleates, ester derivatives of oleates, glycerides, ester derivatives of glycerides, sucrose polyesters, polyglycerolesters, and animal waxes, vegetable waxes, synthetic waxes, petroleum, and mixtures thereof. Particularly useful emulsifiers are lecithin, non-ionic surfactants, such as polyoxyethylene sorbitan fatty acid esters, polyoxyethylene alkyl ethers, or polyoxyethylene castor oil derivatives with one or more polyalcohols, or mixtures thereof.

Emulsifiers may be employed in amounts of up to 2% by weight, more preferably up to 1% by weight based on the dry weight of the formulation.

Plasticisers may be employed in edible film compositions to impart flexibility to the film thereby to increase the ease of handling of the film during storage and during use. As plasticisers there may be mentioned any of those materials commonly used as plasticisers in edible film technology, in particular polyhydric alcohols such as glycerol, polyethylene glycol, propylene glycol, gycerin, sorbitol, maltitol and mannitol.

Plasticisers may be employed up to 5%, more preferably up to 1% by weight based on the dry weight of the formulation.

Colourants and patterns of colours are attractive to the eye and act as a visual cue to consumers identifying certain products with brand owners. The colouring agents useful in the present invention, include pigments such as titanium dioxide, which may be incorporated in amounts of up to about 5 wt %, and preferably less than about 1 wt %. Colorants can also include natural food colours and dyes suitable for food, drug and cosmetic applications. These colorants are known as FD&C dyes and lakes. The materials acceptable for the foregoing spectrum of use are preferably water-soluble, and include FD&C Blue No. 2, which is the disodium salt of 5,5-indigotindisulfonic acid. Similarly, the dye known as Green No. 3 comprises a triphenylmethane dye and is the monosodium salt of 4-[4-N-ethyl-p-sulfobenzylamino) diphenyl-methylene]-[1-N-ethyl-N-p-sulfonium benzyl)-2,5-cyclo-hexadienimine]. A full recitation of all FD&C and D&C dyes and their corresponding chemical structures may be found in the Kirk-Othmer Encyclopedia of Chemical Technology, Volume 5, Pages 857-884, which text is accordingly incorporated herein by reference.

As stated herein above, the edible films may contain other active ingredients such as flavourants, pharmaceutical agents and nutraceutical agents.

The particular flavour ingredients employed depend on the end-use of the edible film. Flavour ingredients may be employed to impart a savoury taste to a food product. However, more preferably the flavour ingredients employed are used in films intended for breath-freshening applications or for confectionery or cosmetic products, or even to impart a pleasant taste, or taste-masking effect, to pharmaceutical or nutraceutical preparations.

Flavourants may be chosen from synthetic flavor oils and flavoring aromatics, and/or oils, oleo resins and extracts derived from plants, leaves, flowers, fruits and so forth, and combinations thereof. Representative flavor oils include: spearmint oil, cinnamon oil, peppermint oil, clove oil, bay oil, thyme oil, cedar leaf oil, oil of nutmeg, oil of sage, and oil of bitter almonds. Also, one can mention artificial, natural or synthetic fruit flavors such as vanilla, chocolate, coffee, cocoa and citrus oil, including lemon, orange, grape, lime and grapefruit and fruit essences including apple, pear, peach, strawberry, raspberry, cherry, plum, pineapple, apricot and so forth. These flavorings can be used individually or in admixture.

Examples of suitable flavour components include without limitation 2-Methyl Pyrazine, Acetophenone Extra, Alcohol C6, Alcohol C8, Aldehyde C7 Heptylic, Aldehyde C8, Aldehyde C9, Allyl Caproate, Amyl Butyrate, Anisicaldhyde, Benzaldehyde, Benzyl Acetate, Benzyl Alcohol, Benzyl Butyrate, Benzyl Formate, Benzyl Iso Valerate, Benzyl Propionate, Butyl Acetate, Camphor, Cinnamic Aldehyde, Cis-3-Hexenol, Cis-3-Hexenyl Acetate, Cis-3-Hexenyl Formate, Cis-3-Hexenyl Propionate, Citronellal, Citronellol, Cuminic Aldehyde, Damascenone, Damascone Alpha, Damascone Beta, Diethyl Malonate, Dimethyl Anthranilate, Dimethyl Benzyl Carbinyl Acetate, Estragole, Ethyl Acetate, Ethyl Aceto Acetate, Ethyl Benzoate, Ethyl Heptoate, Ethyl Salicylate, Ethyl-2-Methyl Butyrate, Eucalyptol, Eugenol, Fenchyl Acetate, Fenchyl Alcohol, Methyl-2-octynoate, 2-sec-Butylcyclohexanone, Styralyl Acetate, Hexyl Acetate, Ionone Alpha, Iso Amyl Acetate, Iso Butyl Acetate, Iso Menthone, Jasmone Cis, Laevo Carvone, Linalool, Linalool Oxide, Melonal, Menthol, Menthone, Methyl Acetophenone, Methyl Amyl Ketone, Methyl Benzoate, Methyl Heptenone, Methyl Hexyl Ketone, Methyl Para Cresol, Methyl Phenyl Acetate, Methyl Salicylate, Neral, Nerol, Para Cresol, Para Cresyl Acetate, Para Tolyl Aldehyde, Phenyl Acetaldehyde, Phenyl Ethyl Acetate, Phenyl Ethyl Butyrate, Phenyl Ethyl Formate, Phenyl Ethyl Iso Butyrate, Phenyl Ethyl Propionate, Phenyl Propyl Acetate, Phenyl Propyl Aldehyde, 4-Methyl-2-(2-methyl-1-propenyl)tetrahydropyran, Styralyl Propionate, Terpineol, Terpinolene, Trans-2-Hexenal, Hexyl Cinnamic Aldehyde Alpha, Oxacycloheptadec-10-en-2-one, Linalyl Benzoate, Cedrol, Benzyl Cinnamate, Linalyl Cinnamate, Phenyl Ethyl Cinnamate, Para Cresyl Phenyl Acetate, Benzyl Salicylate, Hexyl Salicylate, Phenyl Ethyl Salicylate, and Oxacyclohexadecan-2-one.

The amount of flavoring employed is normally a matter of preference subject to such factors as flavor type, individual flavor, and strength desired. Thus, the amount may be varied in order to obtain the result desired in the final product. Such variations are within the capabilities of those skilled in the art without the need for undue experimentation. In general, amounts of about 0.1 to about 30 wt % based on the dry weight of the composition are useable with amounts of about 2 to about 25 wt % being preferred and amounts from about 8 to about 10 wt % are more preferred.

In addition to flavourants, the edible film compositions may contain sweeteners or coolant materials well known in the art for use in oral care, or confectionery products.

Sweeteners include both natural and artificial sweeteners. Suitable sweetener include water soluble sweetening agents such as monosaccharides, disaccharides and polysaccharides such as xylose, ribose, glucose (dextrose), mannose, glatose, fructose (levulose), sucrose (sugar), maltose, water soluble artificial sweeteners such as the soluble saccharin salts, i.e., sodium or calcium saccharin salts, cyclamate salts dipeptide based sweeteners, such a L-aspartic acid derived sweeteners, such as L-aspartyl-L-phenylalaine methyl ester (aspartame).

As coolants one can mention menthol and derivatives thereof such as menthol carboxamide, and menthyl lactate.

In general, the effective amount of sweetener or coolant that is utilized to provide the level of sweetness or coolness desired for a particular composition, will vary with the sweetener or coolant selected. This amount will normally be about 0.01% to about 2% by weight of the composition, based on the dry weight of the composition.

As pharmaceutical agents or nutraceutical agents may be mentioned agents that are intended to be placed in the oral cavity to administer a local effect, or to be absorbed across oral mucosa or open wounds to impart a local or systemic effect. Illustrative categories and representative examples include without limitation:
(a) Antitussives, such as dextromethorphan, dextromethorphan hydrobromide, noscapine, carbetapentane citrate, and chlophedianol hydrochloride;
(b) Antihistamines, such as chlorpheniramine maleate, phenindamine tartrate, pyrilamione maleate, doxylamine succinate, and phenyltoloxamine citrate;
(c) Decongestants, such as phenylpherine hydrochloride, phenylpropanolamine hydrochloride, pseudoephedrine, hydrochloride ephedrine;
(d) Various alkaloids, such as codeine phosphate, codeine sulfate and morphine;
(e) Mineral supplements such as potassium chloride and calcium carbonates, magnesium oxide and other alkali metal and alkaline earth metal salts;
(f) Laxatives, vitamins and antacids;
(g) Ion exchange resins such as cholestyramine;
(h) Anti-cholesterolemic and anti-lipid agents such as gemfibrozil;
(i) Antiarrhythmics such as N-acetyl-procainamide;
(j) Antipyretics such as acetominophen, aspirin and ibuprofen;
(k) Appetite suppressants such as phenylpropanolamine hydrochloride or caffeine; and
(l) Expectorants such as quaifenesin.

Additional useful active medicaments include anti-inflammatory substances, coronary dilators, cerebral dilators, peripheral vasodilators, anti-infectives, psychotropics, antimanics, stimulants, gastro-intestinal sedatives, antidiarrheal preparations, anti-anginal drugs, vasodilators, anti-hypertensive drugs, vasoconstrictors and migraine treatments, antibiotics, tranquilizers, antiphychotics, antitumor drugs, anticoagulants and antithrombotic drugs, hypnotics, sedatives, antiemetics, anti-nauseants, anticonvulsants, neuromuscular drugs, hyper- and hypoglycaemic agents, thyroid and antithyroid preparations, diuretics, antispasmodics, uterine relaxants, nutritional additives, antiobesity drugs, anabolic drugs, erythropoietic drugs, antiasthmatics, cough suppressants, mucolytics, anti-uricemic drugs, and the like. Mixtures of the drugs and medicaments may also be used.

The amount of pharmaceutical or nutraceutical agent employed will depend upon the particular condition to be treated and the particular active agent employed as will be appreciated by the skilled person.

Any of the active agents referred to above may be incorporated directly into the film forming ingredients to form an homogenous mixture that may be cast or extruded into edible film. However, interesting delivery profiles may be achieved by encapsulating the active agent rather than mixing it directly with the film-forming ingredients.

Thus encapsulation may be used to deliver any active agent in a time-controlled manner rather than the immediate release that would occur upon disintegration of the film if the active is mixed directly into the film.

All manner of technical effects relating to delivery of active agent can be achieved using microcapsules to encapsulate active agents. For example, microcapsules may be multifunctional, that is, there may be different populations of microcapsules containing different active agents. Furthermore, not only can the populations of microcapsules be differentiated in terms of the nature of the active agent contained therein, the invention also provides that the microcapsules may comprise different populations in terms of the nature of the encapsulating medium, thereby to influence the release kinetics of the active ingredients contained in different microcapsule populations.

The present invention therefore provides the formulator with considerable latitude to effect release of different active agents on demand, in a time-dependant manner. This can be particularly advantageous in relation to delivery of flavourants The flavourist will have greater latitude to employ the range of his ingredients palette with neither concern for the effects certain ingredients shall have the on film's properties, nor concern for possible ingredient loss, through evaporation or degradation, or due to chromatographic effects, by which is meant the tendency of certain film ingredients to preferentially trap or bind certain flavour ingredients, leading to a perceived imbalance of the flavour delivered to the consumer.

By sequestering active agent from the film-forming material in this way, the invention also enables high loading of active agent without causing any deleterious effects on film stability, such as mechanical stability, hygroscopic stability and the like.

Microcapsules may be employed to contain colourants. It has proven to be technically difficult to introduce colours, and in particular, combinations of colours into an edible film without colours leaching out of their assigned configurations during manufacture and during prolonged periods of storage. Employing pre-coloured populations of microcapsules provides a simple means of colouring films effectively, even with intricate designs. Furthermore, because they are encapsulated, the colours display a considerably reduced tendency to leach or diffuse over time. Notwithstanding that colourants may be introduced into the films by means of encapsulation, it is not precluded to add colour to films using conventional means such as over-printing a film using conventional printing techniques.

Finally, microcapsules can be used to added additional visual impact to the edible film of the present invention by using microcapsule populations having different diameters to give an impression of particulate matter in the film.

Microcapsules my comprise up to about 50 wt % of the composition based on dry weight, more particularly 20 to 50% by weight. Active agent loading may be in the range of 10 to 50% by weight of the microcapsules.

All manner of encapsulation technologies may be applied in the present invention. The particular encapsulating medium used will depend upon the nature of the material to be encapsulated, the desired release kinetics and release profile. Apprised of these factors, the skilled person would not have to resort to inventive activity to select a suitable encapsulating medium to achieve a desired result.

Encapsulation techniques suitable in the present invention include spray-drying, complex coacervation, phase separation techniques (both aqueous and organic phase separation), cyclodextrin molecular encapsulation, yeast-cell encapsulation, in-situ polymerisation, coating, and extrusion.

Spray drying techniques are well known in the art, and can be used by the skilled person to form suitable microcapsules for use in the present invention. In a typical spray-drying technique, an active agent, usually in the form of an oil or in non-aqueous solution is dispersed in an aqueous phase containing film-forming agent to form an emulsion that is fed into a drier through a nozzle that disperses the emulsion into small droplets. The drying conditions are chosen depending on a number of factors relating to desired product characteristics and particle size desired. All manner of film-forming agents may be employed, for example the film-forming carbohydrates, polypeptides and synthetic polymers recited above as being useful edible film forming materials can be employed.

Coacervation is a technique well known in the art and involves the steps of forming a hydrophobic core material containing active agent and emulsifying this in a charged, water-soluble polymer solution having the properties of a protective colloid. Thereafter, an oppositely charged hydrophilic colloid solution is added thereto. Process conditions such as colloid concentration, pH and temperature are controlled to induce phase separation (coacervation) to precipitate a colloid-rich coating of the polymer onto the hydrophobic active-containing core to form a microcapsule wall. The wall is thereafter hardened and rendered insoluble by crosslinking using suitable cross-linkers such as aldehydes, e.g formaldehyde. Materials for use in the capsule wall are well known in the art and include proteins such as gelatin, or film-forming carbohydrates as aforementioned such as alginates.

Encapsulation by extrusion can proceed by making a melt of a matrix material, or a solution of matrix material and co-extruding this with an active agent, using a screw extrude or the like, before drying, or cooling, and grinding to form microcapsules. Matrix material may be formed of a hydrophilic and glassy material such as a water-soluble sugar or sugar mixture. Such matrices are typically impervious to moisture and oxidants and are useful to encapsulate oxidation- and moisture-sensitive active agents. Alternatively, matrix materials may be hydrophobic, such as a vegetable fat, edible waxes, or film-forming carbohydrate, or even mixtures of hydrophobic and glassy-hydrophilic materials; the combinations of materials being selected to achieve a particularly desired delivery effect, having regard to the active agent.

Particles of active agent may also be coated with encapsulating media of any of the film-forming materials referred to herein above. Coating techniques may be used to coat particles, usually solid particles, of active agent, or even may be used to further coat encapsulated forms described herein above.

Coating may be carried out according to known techniques such as spray coating, pan coating, fluid bed coating, rotogranulator coating, annular jet coating, spinning disk coating, spray cooling, spray drying, filtermat drying, Multi Stage Drying (MSD) drum roll coating, freeze drying, and spray chilling.

The skilled person will appreciate that the particular technique used and the encapsulating material employed will depend upon the nature of the active agent to be encapsulated and the type of release characteristic that is sought to be achieved. For example when a flavouring agent is employed that contains a flavourant aldehyde it is preferred not to employ an encapsulating material that contains a polypeptide such as gelatin, as the aldehyde will act to crosslink the polypeptide over prolonged periods of time and this may effect the films ability to hydrate and dissolve, or disperse rapidly when placed, for example, in the mouth. Furthermore, if food acids are employed in an encapsulating media, the encapsulating media preferably contains fatty substances such as edible waxes, and vegetable fats and the like, or some other medium that efficiently encapsulates acids preventing them from leaching into the film.

The edible film as herein above described may be prepared according to a process comprising the steps of preparing an aqueous solution of the film-forming materials, food acid and other optional excipients or active agents as herein above described; mixing the solution until homogenous, and optionally adding microcapsules comprising active agent, and/or food acid; casting the resultant mixture onto a releasable backing media; coating the mixture, for example using conventional knife-coating techniques; and drying the film.

The drying operation may be carried out in a high-temperature air-bath, drying tunnel, vacuum drier, or any other suitable method.

Encapsulation may be employed to encapsulate thermally sensitive agents thereby to permit processing at high temperatures, e.g. up to 90° C. to reduce processing time, without substantially affecting the retention of the active agents or their integrity.

The edible film of the present invention may have a papery, wafer-like consistency that is possessed of sufficient mechanical strength to be handled without special precautions. The film may be provided in continuous sheets that may be rolled onto spools, or cut into sheets and stacked for storage. The films may be cut into any desirable shape for the particular intended end use, and packed in suitable containers.

The thickness of the films can be precisely controlled during the manufacturing process to vary, for example between 5 and 200 microns. The film may be a mono- or multi layer construction. In the case of a monolayer film, microcapsules may be dispersed throughout a monolayer of the film-forming material. If the edible film is in the form of a multilayer, it may comprise a discrete layer consisting of the microcapsules, in addition to the layer of film-forming material. The discrete layer may be formed according to any suitable process, e.g. microparticles may be sprayed or sprinkled onto a wet film before it passes through a drying process.

When placed directly in the mouth, the edible film is quickly hydrated and is softened and develops mucoadhesive properties; thereafter it disperses or dissolves rapidly in the oral cavity, e.g. within about 30 seconds and so does not feel obtrusive or leave an unpleasant mouth feel.

A further advantage of employing microcapsules is that despite the film dissolving or dispersing rapidly in the mouth the microparticles linger in the oral cavity so creating a prolonged release of active agent without attendant adverse mouth feel. One is therefore able to effect a long-lasting taste, or pharmaceutical effect, e.g. 20 minutes or more without attendant adverse mouth feel. In existing commercial products, once the film has dissolved such that there is no longer any unpleasant mouth feel, the flavour sensation or the cosmetic or pharmaceutical effect is lost relatively rapidly thereafter as the active agent is quickly washed away by saliva. The microcapsules, in contrast, are retained in the oral cavity for longer time periods by being physically trapped in pits or fissures in the oral tissue, or by possessing certain mucoadhesive properties similar to those of the film.

There now follows an Example that serves to illustrate the invention.

### EXAMPLE 1

A formulation containing fruit flavours and food acid was formed according to the following methodology.

| | Wet Wt | Dry Wt |
|---|---|---|
| Deionised Water | 582.7 | |
| Pure Coat 792 Modified Starch | 20 | 20 |
| HPMC | 35 | 35 |
| Gelatin | 97 | 97 |
| Polysorbate 80 | 10 | 10 |
| Glycerine | 20 | 20 |
| Sodium Saccharine | 5 | 5 |
| FDC Red 40 Lake | 0.3 | 0.3 |
| Malic acid | 50 | 50 |
| Cherry Emulsion | 130 | 48.1 |
| Cherry Encapsulated | 50 | 50 |
| TOTAL | 1000 | 335.4 |

A solution was made of the cherry flavourant in water. This solution was mixed with the encapsulating agent (Flavorburst® Dry Protein Encapsulate (Givaudan)) for 30 minutes. The Flavourant was absorbed into Flavorburst® after 30 minutes and a dry encapsulated powder was formed.

A solution of starch was made by adding water to the starch and mixing with high shear until a clear solution was formed.

A solution of gelatin was made by heating deionised water to 70 degrees centigrade and adding slowly with stirring fish gelatin. The solution was cooled to 30 degrees.

A coating solution was formed by mixing the aforementioned solutions before mixing in the encapsulated flavourant and emulsifier, colourant and additional flavourant. Mixing was carried out until no lumps were present.

This coating solution was coated onto a polyethylene coated differential release paper using a knife-over-roll coating head. The coated paper was then dried in a drying tunnel to form the film. The film has a paper wafer like consistency. The film was then cut into pieces. Pieces were then tested for sensory response of flavour release in the oral cavity.

The edible film produce was papery, wafer-like in consistency, dry to the touch and capable of being stored in adjacent layers without sticking. When presented to the mouth it imparted an immediate mouth-watering sensation and flavour with the flavour lasting for a period of up to 20 minutes.

When the starch and HPMC were replaced with an alginate film-former, it was not possible to form a good, continuous film. On the contrary, the film was blotchy exhibiting streaks of material and holes.

1. An edible film composition for delivering an active agent to the oral cavity, the composition comprising a water-dispersible film-forming material selected from a cellulose ether and a starch, and a food acid.

2. A composition according to claim 1 wherein the food acid is selected from the group consisting of citric acid, malic acid, glacial acetic acid, anthranilic acid, tartaric acid, tiglic acid, ascorbic acid, benzoic acid, tannic acid, succinic acid, adipic acid, fumaric acid, lactic acid, and mixtures thereof.

3. A composition according to claim 1 wherein the food acid is present in amounts of at least about 8 wt % based on the dry weight of the composition.

4. A composition according to claim 1 wherein the active agent is selected from a flavourant formulation, a pharmaceutical agent, a nutraceutical agent, or mixtures thereof.

5. A composition according to claim 1 wherein active agent is encapsulated in microcapsules that are dispersed throughout the film.

6. A composition according to claim 5 wherein the microcapsules comprise a first population of microcapsules containing a first active ingredient, and a second population of microcapsules containing a second active ingredient.

7. A composition according to claim 1 additionally comprising gelatin and or pectin.

8. A composition according to claim 1 in the form of thin wafer.

9. A composition according to claim 8 wherein the thin wafer is a monolayer.

10. A composition according to claim 8 having a thickness of 5 to 200 microns.

11. Packaging comprising a plurality of wafers according to claim 8.
